(19) United States
(12) Patent Application Publication
(10) Pub. No.: US 2009/0141388 A1
(43) Pub. Date: Jun. 4, 2009

(54) MAGNETIC DISK APPARATUS

(75) Inventor: Yukio URATA, Kawasaki (JP)

Correspondence Address: Fujitsu Patent Center;C/O CPA Global, P.O. Box 52050, Minneapolis, MN, 55402, US

(73) Assignee: FUJITSU LIMTED, Kawasaki (JP)

(21) Appl. No.: 12/325,183

(22) Filed: Nov. 29, 2008

(30) Foreign Application Priority Data
Nov. 30, 2007 (JP) 2007-310743

(51) Int. Cl. G11B 5/02

(52) U.S. Cl. 360/67; G9B/5.026

(57) ABSTRACT

A preamplifier receives a servo gate signal indicating whether magnetic information read out from a disk by a head is servo data for positioning-use or user data stored in a user area available for reading and writing of given data. In the preamplifier, a servo data gain and a user data gain are set in advance. Based on a received servo gate signal, the preamplifier changes the gain depending on whether the head outputs the servo data or the user data.

### BACKGROUND OF THE INVENTION

1. Field of the Invention

The present invention relates to a magnetic disk apparatus that uses a servo gate signal indicating whether magnetic information read out by a head is servo data for positioning-use or user data stored in a user area available for reading and writing of given data.

2. Description of the Related Art

A magnetic disk apparatus is used as one of auxiliary storage apparatuses of a computer. The magnetic disk apparatus includes a disk with a magnetic material applied, and stores therein data by magnetizing the disk.

The magnetic disk apparatus stores therein data that is broadly classified into two types: one is called servo data, and the other user data. The servo data is written in advance for a head position control performed by the magnetic disk apparatus. On the other hand, the user data is written to the disk by the magnetic disk apparatus upon receiving a write command from the computer. Related art is disclosed in, for example, Japanese Patent Application Laid-open No. 2005-302295.

To read out such data from the disk, the magnetic disk apparatus causes a reproducing head to generate a signal from a magnetic field generated on the disk. Since the generated signal is small, the magnetic disk apparatus inputs the signal to a preamplifier so as to amplify the input signal. Here, how much the signal is amplified depends on a gain set to the preamplifier.

In general, the gain is set commonly, not individually, for a servo data signal and a user data signal. That is to say, the preamplifier amplifies signals of the two types with a commonly set gain. For example, the preamplifier amplifies an input signal corresponding to the servo data signal and amplifies an input signal corresponding to the user data signal, similarly by 10 times.

In recent years, recording density of user data in magnetic disk apparatuses has been increasing. In a horizontal recording system, interval of magnetic poles on a disk becomes narrower as the recording density increases. Similarly, in a vertical recording system, areas of the poles on the disk become smaller as the recording density increases. Accordingly, the strength of the magnetic field generated by the magnetic poles becomes weak, so that the user data signal generated by the reproducing head becomes much smaller.

On the contrary, the recording density of the servo data remains still almost the same as it was before because information necessary for the magnetic disk apparatus to control the head position has not been remarkably changed. Thus, there is no need to make the magnetic poles to have a narrower interval or to make the poles to have smaller areas to increase the recording density of the servo data. Accordingly, the magnetic field generated by the magnetic poles has the same strength as it was before. As a result, the difference in signal intensity has been increased between the user data signal and the servo data signal.

In view of the foregoing, if the preamplifier amplifies the servo data signal and the user data signal with a commonly set gain as it was before, the user data signal cannot be processed in some circumstances. Hence, it causes a problem such that the magnetic disk apparatus cannot read out the user data.

Thus, there is a need to reduce a voltage difference between the user data signal and the servo data signal by amplifying the user data signal more than the servo data signal, or by increasing the output of the user data signal, for example, with the reproduction head moved closer to a disk surface to which the user data has been written. Further, it is demanded to improve reliability of reading out the user data by reducing the voltage difference in this manner.

### SUMMARY

It is an object of the present invention to at least partially solve the problems in the conventional technology.

According to one aspect of the present invention, a magnetic disk apparatus includes a head that reads out magnetic information from a magnetic disk surface, a servo gate signal generator that generates a servo gate signal indicating whether the magnetic information read out by the head is servo data for positioning-use or user data stored in a user area available for reading and writing of given data, a read-write processor that performs reading from and writing to the magnetic disk based on the servo gate signal, a preamplifier that amplifies an output from the head, and a gain controller that changes a gain of the preamplifier based on the servo gate signal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a magnetic disk apparatus according to a first embodiment of the present invention;

FIG. 2 is a table of exemplary information stored in a setting information storage unit shown in FIG. 1;

FIG. 3 is a flowchart of a processing operation performed by a gain controller shown in FIG. 1;

FIG. 4 is a schematic diagram of a magnetic disk apparatus according to a second embodiment of the present invention;

FIG. 5 is a table of exemplary information stored in a setting information storage unit shown in FIG. 4;

FIG. 6 is a schematic diagram of a magnetic disk apparatus according to a third embodiment of the present invention;

FIG. 7 is a schematic diagram of a magnetic disk apparatus according to a fourth embodiment of the present invention; and

FIG. 8 is a table of exemplary information stored in a setting information storage unit shown in FIG. 7.

### DETAILED DESCRIPTION OF THE PREFERRED EMBODIMENTS

Exemplary embodiments of a magnetic disk apparatus according to the present invention are described in detail with reference to the accompanying drawings.

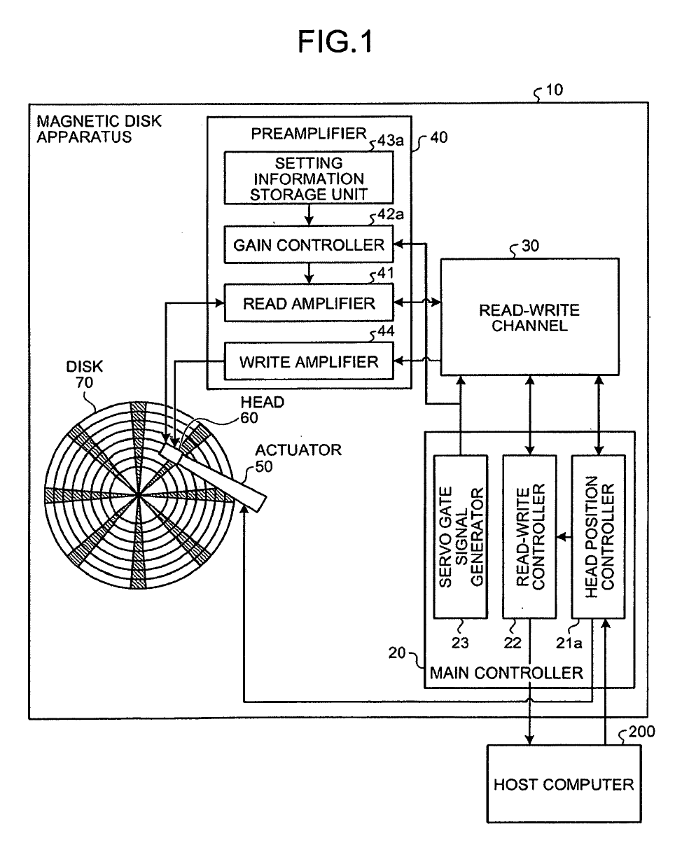

FIG. 1 is a schematic diagram for explaining an overview and a structure of a magnetic disk apparatus according to a first embodiment of the present invention. As shown in FIG. 1, a magnetic disk apparatus 10 includes a main controller 20, a read-write channel 30, a preamplifier 40, an actuator 50, a head 60, and a disk 70. The magnetic disk apparatus 10 is connected to a host computer 200 to serve as an auxiliary storage device. In response to a data write command or a data read command from the host computer 200, the magnetic disk apparatus 10 performs storage or reproduction of data accordingly.

Referring to FIG. 1, the following describes a servo gate signal along with an overview of the elements, specific operations performed by the preamplifier 40 receiving the servo gate signal, and finally operations performed by the main controller 20.

As shown in FIG. 1, the disk 70 is divided into a plurality of ring-shaped areas, each of which is called a track. In the disk 70, each of the tracks is further divided into predetermined areas, to which servo data and user data are written as magnetic information.

Specifically, in the disk 70, the servo data is written to areas indicated by hatched lines and the user data is written to the other areas, as magnetic information. The servo data is magnetic information to be written to the disk 70 in advance to control the position of the head 60 by the magnetic disk apparatus 10. On the other hand, the user data is magnetic information that the magnetic disk apparatus 10 writes to the disk 70 in response to a write command received from the host computer 200.

The disk 70 is rotated at a predetermined rotational frequency during an operation of the magnetic disk apparatus 10.

The head 60 is lifted up from a surface of the disk 70 with a certain space in between, and reads out magnetic information from the surface of the disk 70. Due to the rotation of the disk 70, the head 60 alternately faces servo areas to which the magnetic information being the servo data is written and data areas to which the magnetic information being the user data is written. Accordingly, the head 60 generates a servo data signal and a user data signal based on the magnetic information written to the respective areas, and outputs the signals to the preamplifier 40.

The preamplifier 40 amplifies each of the output signals from the head 60 with a predetermined gain, and outputs the signal to the read-write channel 30.

As described above, either the servo data signal or the user data signal is constantly input to the read-write channel 30 during the operation of the magnetic disk apparatus 10.

In response to a command from the main controller 20, the read-write channel 30 performs various signal processes on the input signal from the preamplifier 40, and outputs the processed signal to the main controller 20.

When performing the aforementioned signal processes, the read-write channel 30 needs to identify whether the signal received from the preamplifier 40 is a servo data signal or a user data signal, so as to only process the servo data signal and output to a processing result to the main controller 20 or to only process the user data signal to output a processing result to the main controller 20.

The servo gate signal is a signal that indicates whether the magnetic information read out by the head 60 is the servo data for positioning-use or the user data stored in a user area available for reading and writing of given data. The servo gate signal is generated at a servo gate signal generator 23 in the main controller 20. Based on the servo gate signal, the read-write channel 30 processes an input signal from the preamplifier 40 individually, depending on whether the signal is the servo data signal or the user data signal.

The servo gate signal may be, for example, a signal having an output level that alternately changes between a first predetermined value and a second predetermined value at certain intervals. In this case, the read-write channel 30 determines a signal received from the preamplifier 40 to be the servo data signal when receiving a servo gate signal at the first predetermined value. On the contrary, if the output level is changed and the servo gate signal is received at the second predetermined value, the read-write channel 30 determines a signal received from the preamplifier 40 to be the user data signal.

The servo gate signal is explained above. The following describes specific operations performed by the preamplifier 40 receiving the servo gate signal. In the magnetic disk apparatus 10 according to the first embodiment of the present invention, the servo gate signal is input to the preamplifier 40 as well as to the read-write channel 30.

The preamplifier 40 amplifies an output from the head 60. The preamplifier 40 includes a setting information storage unit 43a, a gain controller 42a, a read amplifier 41, and a write amplifier 44. The servo gate signal is received at the gain controller 42a.

The read amplifier 41 amplifies an output from the head with a predetermined gain. The read amplifier 41 uses a variable gain.

The write amplifier 44 amplifies an output from the read-write channel 30 with a predetermined gain, and outputs the amplified signal to the head 60.

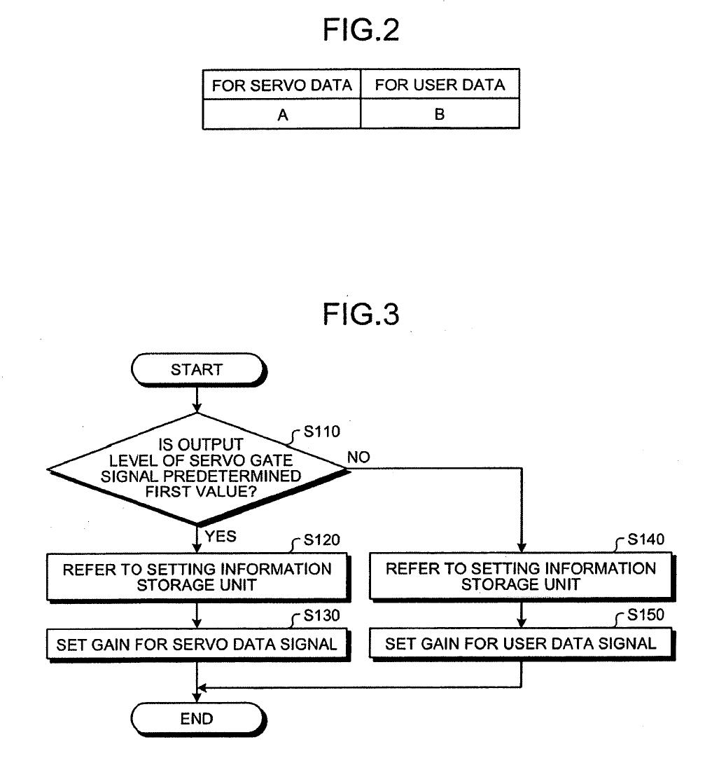

The setting information storage unit 43a stores therein a first gain for a servo data signal and a second gain for the user data signal. For example, as shown in FIG. 2, the setting information storage unit 43a stores therein a gain “A” for the servo data signal and a gain “B” for the user data signal. FIG. 2 is a table of exemplary information stored in the setting information storage unit 43a.

The gain controller 42a changes the gain of the read amplifier 41 based on the servo gate signal, depending on whether the magnetic information is the servo data or the user data.

For example, as to the servo gate signal having an output level that alternately changes between the first predetermined value and the second predetermined value at certain intervals, a processing operation performed by the gain controller 42a are described with reference to a flowchart shown in FIG. 3.

FIG. 3 is a flowchart of a processing operation performed by the gain controller 42a. The process flow shown in FIG. 3 is repeatedly performed during the operation performed by the magnetic disk apparatus 10.

If an output level of the received servo gate signal is the first predetermined value (YES at Step 110), the gain controller 42a determines that a signal being received from the head 60 is a servo data signal. The gain controller 42a then refers to the setting information storage unit 43a (Step S120), and sets the gain of the read amplifier 41 to the gain “A” for a servo data signal (Step S130).

On the contrary, if the output level of the received servo gate signal is the second predetermined value (NO at Step S110), the gain controller 42a determines that a signal being received from the head 60 is a user data signal. The gain controller 42a then refers to the setting information storage unit 43a (Step S140), and sets the gain of the read amplifier 41 to the gain “B” for the user data signal (Step S150).

The operations performed by the preamplifier 40 are explained above. The following describes the main controller 20, and the processes for writing or reading of data, performed by the magnetic disk apparatus 10 serving as an auxiliary storage device of the host computer 200.

The main controller 20 performs overall control of the magnetic disk apparatus 10, and performs processes according to a data write command or a data read command received from the host computer 200. Specifically, the main controller 20 includes a head position controller 21a, a read-write controller 22, and the servo gate signal generator 23. To provide a data read command, the host computer 200 sends to the magnetic disk apparatus 10 a read command and read position information indicating from where on the disk 70 to read data. To provide a write command, the host computer 200 sends to the magnetic disk apparatus 10 a write command, write data, and write position information indicating where on the disk 70 the data is written.

The head position controller 21a moves the head 60 to a target track by controlling the actuator 50.

Specifically, the head position controller 21a receives the read command and the read position information sent from the host computer 200. The head position controller 21a then commands the read-write channel 30 to process the servo data signal and notify the current position of the head 60 on the disk 70. Accordingly, information on the current position on the disk 70 is output from the read-write channel 30. The head position controller 21a controls the actuator 50 based on the information on the current position on the disk 70 and the read position information, so as to move the head 60 to the target track. After positioning the head 60, the head position controller 21a outputs the read command and the read position information to the read-write controller 22.

On the contrary, when receiving the write command, the write data, and the write position information sent from the host computer 200, the head position controller 21a commands the read-write channel 30 to process the servo data signal and acquire the current position of the head 60 on the disk 70. Accordingly, information on the current position on the disk 70 is output from the read-write channel 30. The head position controller 21a controls the actuator 50 based on the information on the current position on the disk 70 and the write position information, so as to move the head 60 to the target track. After positioning the head 60, the head position controller 21a outputs the write command, the write data, and the write position information to the read-write controller 22.

The read-write controller 22 stores the write data sent from the host computer 200 in the disk 70. The read-write controller 22 also reproduces the data from the disk 70 and sends the reproduced data to the host computer 200.

Specifically, upon receiving the read command and the read position information from the head position controller 21a, the read-write controller 22 commands the read-write channel 30 to process the servo data signal and acquire the current position of the head 60 on the track. Accordingly, information on the current position on the track is output from the read-write channel 30. Based on the information on the current position on the track and the read position information, the read-write controller 22 commands the read-write channel 30 to process the user data signal and acquire user data. Accordingly, the user data is output from the read-write channel 30, and the read-write controller 22 sends the user data to the host computer 200.

On the contrary, upon receiving the write command, the write data, and the write position information from the head position controller 21a, the read-write controller 22 commands the read-write channel 30 to process the servo data signal and acquire the current position of the head 60 on the track. Accordingly, information on the current position on the track is output from the read-write channel 30. The read-write controller 22 outputs the write data to the read-write channel 30 at predetermined timing based on the information on the current position on the track and the write position information.

As described, the head position controller 21a and the read-write controller 22 provide various commands to the read-write channel 30. Then, the read-write channel 30 receives a servo data signal or a user data signal amplified by the preamplifier 40 with a gain individually set for each signal. Accordingly, even with a large voltage difference between the user data signal and the servo data signal, as long as appropriate gains are set for respective signals of the two types, such it is avoided that the user data signal cannot be processed in the read-write channel 30 and the magnetic disk apparatus 10 cannot read out data.

According to the first embodiment described above, the servo gate signal is also input to the preamplifier 40, and the gain controller 42a changes the gain of the read amplifier 41 for the servo data signal and the user data signal based on the servo gate signal. With the above arrangement, the gain of the preamplifier 40 is changed depending on whether the magnetic information is the servo data or the user data. Therefore, the preamplifier 40 amplifies the user data signal more than the servo data signal so as to be able to reduce the voltage difference between the signals. Accordingly, improved reliability is achieved for reading out the user data.

The first embodiment describes the magnetic disk apparatus having one disk. In a second embodiment of the present invention, a magnetic disk apparatus has a plurality of disks.

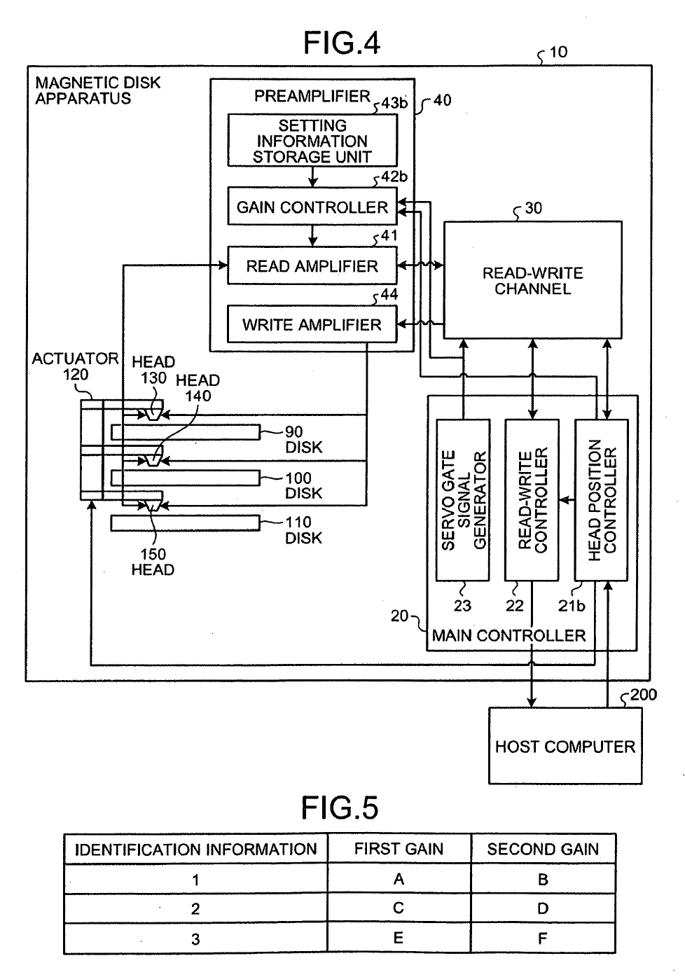

FIG. 4 is a schematic diagram of a magnetic disk apparatus according to the second embodiment. As shown in FIG. 4, the magnetic disk apparatus 10 includes the main controller 20, the read-write channel 30, the preamplifier 40, disks 90 to 110, an actuator 120, and heads 130 to 150. The main controller 20 includes a head position controller 21b, the read-write controller 22, and the servo gate signal generator 23. The preamplifier 40 includes the setting information storage unit 43b, a gain controller 42b, the read amplifier 41, and the write amplifier 44. The following describes the disks 90 to 110, the actuator 120, the heads 130 to 150, the head position controller 21b, the setting information storage unit 43b, and the gain controller 42b, omitting the elements being the same as those of the first embodiment.

Each of the disks 90 to 110 is assigned with identification information to distinguish disks from each other. For example, the disk 90 is assigned with identification information “1,” the disk 100 with identification information “2,” and the disk 110 with identification information “3.”

Each of the heads 130 to 150 reads out magnetic information from a corresponding disk surface, and inputs a signal generated based on the magnetic information to the read amplifier 41. Each of the heads 130 to 150 also receives data output from the write amplifier 44, and writes the data as magnetic information to a corresponding disk surface. The main controller 20 selectively switches the input from the heads 130 to 150 to the read amplifier 41 and the output from the write amplifier 44 to the heads 130 to 150, after determining which disk to access.

The actuator 120 moves the heads 130 to 150 to predetermined positions at one time, and fixes the heads 130 to 150 to the predetermined positions. Specifically, under the control of the head position controller 21b, the actuator 120 moves the heads 130 to 150 to respective predetermined tracks on the disks 90 to 110, and fixes the heads 130 to 150 thereto.

The head position controller 21b outputs to the gain controller 42b identification information of a disk to be accessed, and moves the heads 130 to 150 to the predetermined positions at one time by controlling the actuator 120.

Specifically, the head position controller 21b receives the read command and the read position information from the host computer 200. Based on the read position information, the head position controller 21b then determines which disk to access, and outputs identification information of the disk to the gain controller 42b. For example, the head position controller 21b outputs the identification information “1” to the gain controller 42b, based on the read position information.

The head position controller 21b will be further described later, and now the setting information storage unit 43b and the gain controller 42b are described.

The setting information storage unit 43b associates identification information with the first gain and the second gain, and stores therein the identification information associated with the first gain and the second gain for each of the plurality of disks. For example, as shown in FIG. 5, the setting information storage unit 43b associates the identification information “1” with the first gain “A” and the second gain “B” so as to store them therein. FIG. 5 is a table of exemplary information stored in the setting information storage unit 43b.

The gain controller 42b changes the gain depending on which of the heads 130 to 150 outputs a signal to be amplified.

The following describes a processing operation performed by the gain controller 42b of when, for example, the servo gate signal has an output level that alternately changes between a first predetermined value and a second predetermined value at certain intervals and the identification information “1” is received from the head position controller 21b.

If the output level of the received servo gate signal is the first predetermined value, the gain controller 42b determines that a signal being received from the head 130 is a servo data signal. The gain controller 42b then refers to the setting information storage unit 43b, and sets the gain of the variable amplifier to the first gain “A” for the identification information “1.”

On the contrary, if the output level of the received servo gate signal is the second predetermined value, the gain controller 42b determines that a signal being received from the head 130 is a user data signal. The gain controller 42b then refers to the setting information storage unit 43b, and sets the gain of the variable amplifier to the second gain “B” for the identification information “1.”

As described above, the input from the heads 130 to 150 to the read amplifier 41 is selectively switched, and the gain set for the read amplifier 41 is also changed.

The explanation now returns to the head position controller 21b. After outputting the identification information to the gain controller 42b, the head position controller 21b commands the read-write channel 30 to process the servo data signal and notify the current position of the head on the disk. As mentioned before, in the preamplifier 40, the gain for the servo data signal and the gain for the user data signal have been changed to the gains corresponding to the disk 90 (the identification information “1”) to be accessed. If the gains are appropriate values, information of the current position of the head 130 on the disk 90 is output from the read-write channel 30. The head position controller 21b controls the actuator 120 based on the information of the current position on the disk 90 and the read position information, so as to move the heads 130 to 150 to the target tracks at one time.

After positioning the heads, the head position controller 21b outputs the read command and the read position information to the read-write controller 22.

On the contrary, when receiving the write command, the write data, and the write position information from the host computer 200, the head position controller 21b determines based on the write position information which disk to access, and outputs the identification information of the disk to the gain controller 42b. For example, the head position controller 21b outputs the identification information “2” to the gain controller 42b based on the write position information.

After outputting the identification information to the gain controller 42b, the head position controller 21b commands the read-write channel 30 to process the servo data signal and notify the current position of the head on the disk. As described above, in the preamplifier 40, the gain for the servo data signal and the gain for the user data signal have been changed to the gains corresponding to the disk 100 (the identification information “2”) to be accessed. If the gains are appropriate values, information of the current position of the head 140 on the disk 100 is output from the read-write channel 30. The head position controller 21b controls the actuator 120 based on the information on the current position of the head 140 on the disk 100 and the write position information, so as to move the heads 130 to 150 to the target tracks at one time.

After positioning the heads, the head position controller 21b outputs the write command, the write data, and the write position information to the read-write controller 22.

The foregoing describes the magnetic disk apparatus 10 including a plurality of disks. According to the second embodiment described above, appropriate gains can be set in the preamplifier 40 for each head, even when the disks in the magnetic disk apparatus 10 and the heads corresponding to the disks have different properties and the heads output different values. With the aforementioned arrangement, even when the magnetic information is read out by any head, the user data signal is amplified more than the servo data signal, so that a voltage difference between the signals can be reduced. Accordingly, improved reliability is achieved for reading out the user data.

In the first embodiment, the servo data signal and the user data signal are amplified individually by changing the gain of the read amplifier 41. In a third embodiment of the present invention, a preamplifier includes two amplifiers each having a fixed gain, so that the servo data signal and the user data signal are amplified individually by switching a destination of the output from the head.

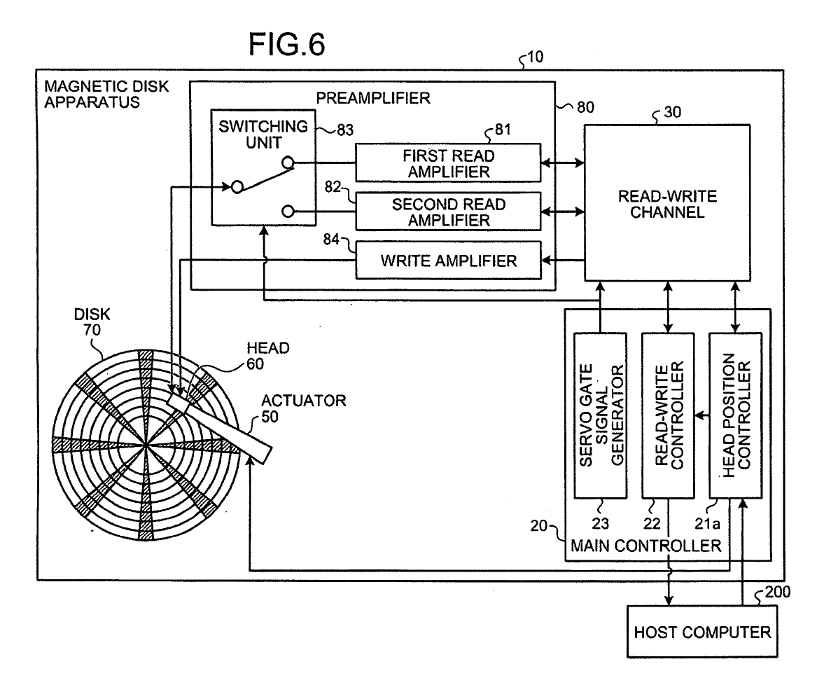

FIG. 6 is a schematic diagram of a magnetic disk apparatus according to the third embodiment. As shown in FIG. 6, the magnetic disk apparatus 10 includes the main controller 20, the read-write channel 30, the actuator 50, the head 60, the disk 70, and a preamplifier 80. The main controller 20, the read-write channel 30, the actuator 50, the head 60, and the disk 70 are already described in the first embodiment, so that the description thereof is omitted and only the preamplifier 80 is described below.

The preamplifier 80 is an amplifier that amplifies an output signal from the head. The preamplifier 80 includes a first read amplifier 81, a second read amplifier 82, a switching unit 83, and a write amplifier 84. The servo gate signal is received at the switching unit 83.

The first read amplifier 81 has a gain set for the servo data signal. With the gain, the first read amplifier 81 amplifies a signal output from the switching unit 83, and inputs the amplified signal to the read-write channel 30.

The second read amplifier 82 has a gain set for the user data signal. With the gain, the second read amplifier 82 amplifies a signal output from the switching unit 83, and inputs the amplified signal to the read-write channel 30.

The switching unit 83 changes the gain of the preamplifier 80 based on the servo gate signal, depending on whether the magnetic information is the servo data or the user data.

Specifically, the switching unit 83 switches the destination of a received signal to the first read amplifier 81 when receiving the servo data signal, while the switching unit 83 switches the destination of a signal to the second read amplifier 82 when receiving the user data signal.

The following describes a processing operation performed by the switching unit 83 when, for example, the servo gate signal has an output level that alternately changes between a first predetermined value and a second predetermined value at certain intervals.

If an output level of the received servo gate signal is the first predetermined value, the switching unit 83 determines that a signal being received from the head 60 is the servo data signal. The switching unit 83 then switches the destination of the servo data signal to the first read amplifier 81. On the contrary, if the output level of the received servo gate signal is the second predetermined value, the switching unit 83 determines that a signal being received from the head 60 is the user data signal. The switching unit 83 then switches the destination of the user data signal to the second read amplifier 82.

The write amplifier 84 amplifies an output signal from the read-write channel 30 with a predetermined gain, and outputs the amplified signal to the head 60.

According to the third embodiment described above, the servo gate signal is also input to the preamplifier 80. Based on the servo gate signal, the switching unit 83 switches the destination of the servo data signal and the user data signal to either of the two amplifiers having different gains. With the aforementioned arrangement, the gain of the preamplifier 80 is changed depending on whether the magnetic information is the servo data or the user data. This enables the preamplifier 80 to amplify the user data signal more than the servo data signal, thus reducing the voltage difference between the signals. Accordingly, improved reliability is achieved for reading out the user data.

In a fourth embodiment of the present invention, the preamplifier 40 according to the first embodiment uses the servo gate signal to set a heater temperature for adjusting a head temperature.

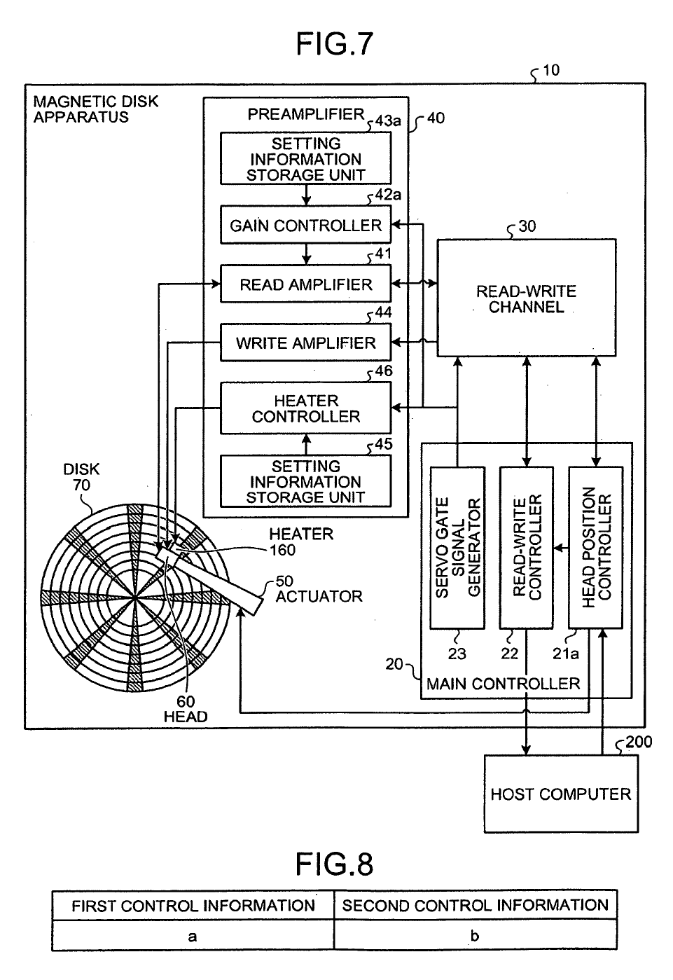

FIG. 7 is a schematic diagram of a magnetic disk apparatus according to the fourth embodiment. As shown in FIG. 7, the magnetic disk apparatus 10 includes the main controller 20, the read-write channel 30, the preamplifier 40, the actuator 50, the head 60, the disk 70, and a heater 160. The main controller 20, the read-write channel 30, the actuator 50, the head 60, and the disk 70 are already described in the first embodiment, so that the description thereof is omitted and only the preamplifier 40 and the heater 160 are described below.

The heater 160 adjusts the temperature of the head 60. Specifically, the heater 160 changes temperature of the head 60 based on control information output from a heater controller 46, so as to transmit the heat to the head 60 or derive the heat from the head 60.

The preamplifier 40 amplifies an output from the head 60. The preamplifier 40 includes the setting information storage unit 43a, the gain controller 42a, the read amplifier 41, the write amplifier 44, the setting information storage unit 45, and the heater controller 46. The servo gate signal is received at the gain controller 42a and the heater controller 46.

The setting information storage unit 45 stores therein first control information for setting the temperature of the heater 160 to be a first predetermined value when the head 60 is located over the servo data area, and second control information for setting the temperature of the heater 160 to be a second predetermined value when the head 60 is located over the user data area. For example, as shown in FIG. 8, the setting information storage unit 45 stores therein the first control information “a” and the second control information “b.” FIG. 8 is a table of exemplary information stored in the setting information storage unit 45.

The heater controller 46 changes the temperature set for the heater 160 based on the servo gate signal, depending on whether the magnetic information is the servo data or the user data. The following describes a processing operation performed by the heater controller 46 when, for example, the servo gate signal has an output level that alternately changes between a first predetermined value and a second predetermined value.

If an output level of the received servo gate signal is the first predetermined value, the heater controller 46 determines that the head 60 is currently located over the servo data area. The heater controller 46 then refers to the setting information storage unit 45, and outputs the first control information “a” to the heater 160. Accordingly, the heater 160 adjusts the temperature of the head 60 based on the first control information “a,” so that the head 60 thermally expands according to the temperature.

On the contrary, if the output level of the received servo gate signal is the second predetermined value, the heater controller 46 determines that the head 60 is currently located over the user data area. The heater controller 46 then refers to the setting information storage unit 45, and outputs the second control information “b” to the heater 160. Accordingly, the heater 160 adjusts the temperature of the head 60 based on the second control information “b,” so that the head 60 thermally expands according to the temperature.

According to the fourth embodiment described above, the servo gate signal is also input to the preamplifier 40, and the heater controller 46 adjusts the temperature of the head 60 based on the servo gate signal. As a result, a space between a surface of the disk 70 and the head 60 can be changed in the servo area and the data area individually, so that the output from the head 60 can be adjusted by bringing the head 60 closer to the data area. This enables a reduction in the voltage difference between the servo data signal and the user data signal upon reproduction of the signals, thus achieving improved reliability for reading out the user data.

According to an embodiment of the present invention, an apparatus enables a preamplifier to amplify the user data signal more than the servo data signal to reduce the voltage difference between the signals, thus achieving improved reliability for reading out the user data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic disk apparatus comprising:
a head that reads out magnetic information from a magnetic disk surface;
a servo gate signal generator that generates a servo gate signal indicating whether the magnetic information read out by the head is servo data for positioning-use or user data stored in a user area available for reading and writing of given data;
a read-write processor that performs reading from and writing to the magnetic disk based on the servo gate signal;
a preamplifier that amplifies an output from the head; and
a gain controller that changes a gain of the preamplifier based on the servo gate signal.

2. The magnetic disk apparatus according to claim 1, wherein
the head includes a plurality of heads each of which is provided for each of a plurality of magnetic disks,
the preamplifier amplifies outputs from the heads, and
the gain controller changes the gain depending on which of the heads outputs a signal to be amplified by the preamplifier.

3. A magnetic disk apparatus comprising:
a head that reads out magnetic information from a magnetic disk surface;
a servo gate signal generator that generates a servo gate signal indicating whether the magnetic information read out by the head is servo data for positioning-use or user data stored in a user area available for reading and writing of given data;
a read-write processor that performs reading from and writing to the magnetic disk based on the servo gate signal;
a heater that adjusts a temperature of the head to a setting temperature; and
a temperature controller that changes the setting temperature based on the servo gate signal.
